(19) United States
(12) Patent Application Publication
(10) Pub. No.: US 2025/0005367 A1
(43) Pub. Date: Jan. 2, 2025

(54) INTERVAL-BASED OFFLINE POLICY EVALUATION WITHOUT DATA COVERAGE AND CORRECTLY-SPECIFIED MODELS

(71) Applicant: International Business Machines Corporation, Armonk, NY (US)

(72) Inventors: Kohei Miyaguchi, Tokyo (JP); Hiroshi Kajino, Tokyo (JP)

(21) Appl. No.: 18/342,113

(22) Filed: Jun. 27, 2023

(51) Int. Cl. G06N 3/092

(52) U.S. Cl. CPC G06N 3/092

(57) ABSTRACT

A method of performing an Offline Policy Evaluation (OPE) based on the importance sampling includes collecting a dataset D, wherein D is given by [symbol] :={(sᵢ, aᵢ, rᵢ, sᵢ′)}ᵢ₌₁ⁿ, identifying a target policy π, calculating a support function estimate \hat{σ}(s, a), wherein the support function estimate \hat{σ}(s, a) is responsive to the dataset D, identifying a discriminator set F; calculating an importance weight estimate ŵ(s, a) responsive to the dataset D, the target policy π, the support function estimate \hat{σ} and the discriminator set F and calculating a minimax interval estimate Ĉ responsive to the dataset D and the importance weight estimate ŵ.

### BACKGROUND

The present invention generally relates to Offline Policy Evaluation, and more specifically, to Interval-Based Offline Policy Evaluation without Data Coverage and Correctly-Specified Models.

In the context of Reinforcement Learning (RL), Offline Policy Evaluation (OPE) is the problem of evaluating the value of a candidate policy using data that was previously collected some existing logging policy. OPE is of crucial importance in many applications, such as medicine, healthcare, robotics, etc., where the cost of actually executing a bad policy could be catastrophic. Unfortunately, in many of the applications that inspire OPE, it may be reasonably expected that there may be a discrepancy between the policy for logging available data and the target policy.

Put another way, OPE is the task of evaluating a decision-making policy π that may be based on offline data [symbol] , where the value of a may be defined by the expected cumulative discounted reward given by:

$$J ( π ) := 𝔼 [ ( 1 - γ ) {\sum }_{t = 0}^{∞} {γ}^{t} \cdot r ( {s}_{t} , {a}_{t} ) ] , \qquad ( Equation 1 )$$

where γ∈(0,1) is the discounting factor, r(s, a) is the reward function, sₜ is the environment state after t units of interaction and aₜ is the action of π in response to sₜ. It can be thought of as a proxy for expensive/risky online policy evaluation and may be essential to real-world application of RL. For example, consider the situation of on-line evaluation of arbitrary autonomous vehicles or medical treatment policies. These situations have the real risk of hurting people and thus, need intensive human supervision. Previous OPE methods are impractical in the sense that they are built under the assumptions of data coverage or a correctly-specified model, where the data coverage may indicate that the dataset contains all of the states and action that can possibly be encountered in the online evaluation and the model is correctly-specified if it represents the true environment faithfully. Since both conditions are not only difficult to satisfy, but also difficult to verify, the outputs of previous OPE methods may be unstable and unreliable.

Additionally, Offline Policy Interval Estimation (OPI) is an interval extension of OPE and generates results as an interval rather than a data point, which indicates the uncertainty of the evaluation. Accordingly, an OPI Estimation is important in OPE because, when the data coverage is insufficient relative to the complexity of the environmental model, the true policy value is indeterminant even with an infinite sample size, and thus any OPE method can be biased. Moreover, previous OPE/OPI methods are impractical in the sense that they assume either the sufficient exploration or strong realizability, both of which are expensive or impossible to satisfy in real-life applications. As discussed briefly above, “sufficient exploration” is the technical term indicating that the dataset contains all of the states and actions that can possibly be encountered in the future and “strong realizability” is the technical term indicating the availability of a correct environmental mode with known complexity. Unfortunately, methods relying on “sufficient exploration” tend to perform poorly if the dataset has poor coverage in the state-action space and methods relying on “strong realizability” tend to be sensitive to the choice of their hyperparameters.

### SUMMARY

Embodiments of the present invention are directed to a method of performing an Offline Policy Evaluation (OPE) based on the importance sampling. According to an aspect, the method includes collecting a dataset D, wherein D is given by [symbol] :={(sᵢ, aᵢ, rᵢ, sᵢ′)}ᵢ₌₁ⁿ, identifying a target policy π, calculating a support function estimate \hat{σ}(s, a), wherein the support function estimate \hat{σ}(s, a) is responsive to the dataset D, identifying a discriminator set F, calculating an importance weight estimate ŵ(s, a) responsive to the dataset D, the target policy π, the support function estimate \hat{σ} and the discriminator set F and calculating a minimax interval estimate Ĉ responsive to the dataset D and the importance weight estimate ŵ.

Embodiments of the present invention are directed to a computing system having a machine learning system for implementing a method for performing an Offline Policy Evaluation (OPE) based on the importance sampling. According to an aspect, the computing system is configured to collect a dataset D, wherein D is given by [symbol] :={(sᵢ, aᵢ, rᵢ, sᵢ′)}ᵢ₌₁ⁿ, identifying a target policy π, calculate a support function estimate \hat{σ}(s, a), wherein the support function estimate \hat{σ}(s, a) is responsive to the dataset D; identify a discriminator set F, calculate an importance weight estimate ŵ(s, a) responsive to the dataset D, the target policy π, the support function estimate \hat{σ} and the discriminator set F and calculate a minimax interval estimate Ĉ responsive to the dataset D and the importance weight estimate ŵ.

Embodiments of the present invention are directed to a computer program product including a computer readable storage medium having program instructions embodied therewith, the program instructions executable by a processor to cause the processor to perform operations including performing an Offline Policy Evaluation (OPE) based on the importance sampling, wherein performing includes collecting a dataset D, wherein D is given by [symbol] :={(sᵢ, aᵢ, rᵢ, sᵢ′)}ᵢ₌₁ⁿ, identifying a target policy π, calculating a support function estimate \hat{σ}(s, a), wherein the support function estimate \hat{σ}(s, a) is responsive to the dataset D, identifying a discriminator set F, calculating an importance weight estimate ŵ(s, a) responsive to the dataset D, the target policy π, the support function estimate \hat{σ} and the discriminator set F and calculating a minimax interval estimate Ĉ responsive to the dataset D and the importance weight estimate ŵ.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 shows a block diagram of an example computer system for use in accordance with one or more embodiments of the present invention;

FIG. 2 shows a graph illustrating a support function σ(s, a) for a given data density β(s, a), in accordance with one or more embodiments of the present invention;

FIG. 3 shows a graph illustrating the results of the method of the invention being used to solve an Interval-Based Offline Policy Evaluation problem without relying on Data Coverage and Correctly-Specified Model, in accordance with one or more embodiments of the present invention; and

FIG. 4 is an operational block diagram illustrating a method for solving an Interval-Based Offline Policy Evaluation problem without relying on Data Coverage and Correctly-Specified Model, in accordance with one or more embodiments of the present invention.

### DETAILED DESCRIPTION

As discussed briefly above, current OPE methods rely on “sufficient exploration” and “strong realizability” to evaluate the value of a candidate policy. Unfortunately, this results in an evaluation that may not be reliable. The present invention provides a method that does not rely on the “sufficient exploration” and the “strong realizability” to evaluate the value of a candidate policy, thereby resulting in a more stable, reliable and robust method of evaluation. In an embodiment, the policy value may be defined as the expected cumulative discounted reward, which may be given by:

$${J}_{M} ( π ) := 𝔼 [ ( 1 - γ ) {\sum }_{t = 0}^{∞} {γ}^{t} {r}_{t} ] , \qquad ( Equation 2 )$$

where, M≡(ι, R, T, γ) is the Markov decision process (MDP), ι(s₀) is the initial state distribution, T(sₜ₊₁|sₜ, aₜ) is the state transition, R(rₜ|sₜ, aₜ) is the reward distribution (normalized as |rₜ|≤1) and γ∈(0,1) is the discounting factor. The offline data [symbol] is given by: [symbol] ≡{(sᵢ, aᵢ, rᵢ, sᵢ′)}ᵢ₌₁ⁿ, which may be sampled from the following distribution:

$${G}_{β , M} ( 𝒟 ) = {\prod }_{i = 1}^{n} β ( {s}_{i} , {a}_{i} ) R ( {r}_{i} \vert {s}_{i} , {a}_{i} ) T ( {s}_{i}^{′} \vert {s}_{i} , {a}_{i} ) , \qquad ( Equation 3 )$$

where β(sᵢ, aᵢ) is the behavior distribution. Moreover, the minimax interval may be defined as the minimal assumption-free interval estimate and may be given by,

$${C}_{★} ( π ) := \{ {J}_{\tilde{M}} ( π ) \vert {G}_{β , \tilde{M}} ( 𝒟 ) = {G}_{β , M} ( 𝒟 ) \} . \qquad ( Equation 4 )$$

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

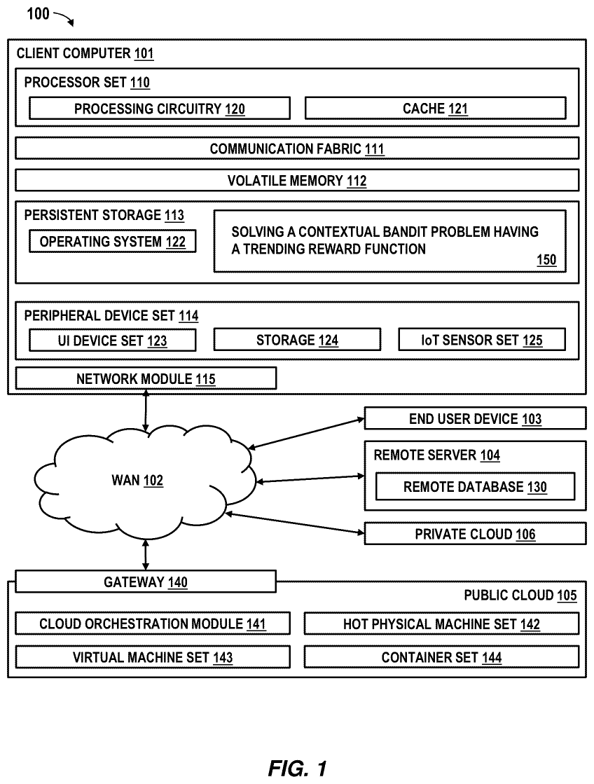

Referring to FIG. 1, computing environment 100 contains an example of an environment for the execution of at least some of the computer code involved in performing the inventive methods, such as for solving an Interval-Based Offline Policy Evaluation problem without Data Coverage and Correctly-Specified Model 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks. More specifically, one or more embodiments described herein can incorporate and utilize rule-based decision making and artificial intelligence (AI) reasoning to accomplish the various operations described herein, namely containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

In an embodiment, a method for performing an Interval-Based Offline Policy Evaluation (OPE) is provided based on the importance sampling, where the importance sampling is computed using a modification of the Minimax Weight Learning (MWL). The method 100 includes computing the interval given by,

$$\begin{matrix}\hat{C} := [ {J}_{n} ( \hat{w} ) - {ϵ}_{n} ( \hat{w} ) , & {J}_{n} ( \hat{w} ) + {ϵ}_{n} ( \hat{w} ) ]\end{matrix} , \qquad ( Equation 5 )$$

where Jₙ(ŵ) is the importance-sampling estimate and is given by,

$${J}_{n} ( \hat{w} ) := \frac{1}{n} {\sum }_{i = 1}^{n} [ {r}_{i} \cdot \hat{w} ( {s}_{i} , {a}_{i} ) ] , \qquad ( Equation 6 )$$

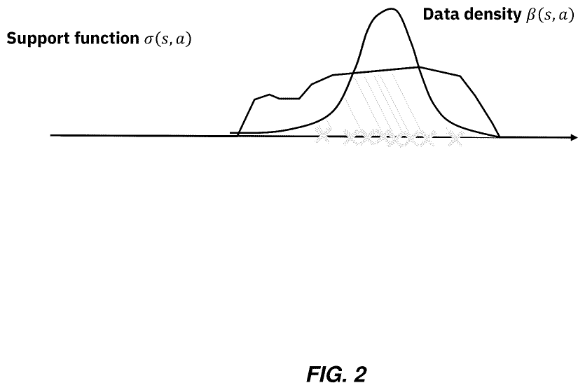

and ∈ₙ(ŵ) is the error estimate and is given by,

$${ϵ}_{n} ( \hat{w} ) := - 1 - \frac{1}{n} {\sum }_{i = 1}^{n} \hat{w} ( {s}_{i} , {a}_{i} ) , \qquad ( Equation 7 )$$

where the importance weight ŵ(s, a) is computed with a modification of the MWL and is given by,

$$\hat{w} := {arg min}_{w ∈ 𝒲} {max}_{f ∈ ℱ} {L}_{n} ( w ; σ f ) , \qquad ( Equation 8 )$$

where Lₙ(w, f) is the loss function of MWL, [symbol] is the hypothesis sets of the importance weight, [symbol] is the hypothesis sets of the “discriminator” and σ is the support function satisfying supp(σ)=supp(β) (e.g.) σ=β, \sqrt{β}, etc. This is shown in FIG. 2 which illustrates a support function σ(s, a) for a given data density β(s, a).

It should be appreciated that the MWL is used to approximate a solution to the Adjoint Bellman Equation (ABE) to get the importance-weight w of β as given by:

$$w β = {ℬ}^{′} ( w β ) .$$

Therefore, if the ABE has a solution w_{*}, then the minimax interval C_{*} may be expressed in terms of w_{*} as:

$${C}_{★} = \{ 𝔼 {J}_{n} ( {w}_{★} ) \} . \qquad ( Equation 9 )$$

Accordingly, the MWL and the associated importance-sampling estimate Jₙ(ŵ) is shown to be stable and reliable.

On the other hand, if the data coverage is insufficient, the ABE has no solution and the MWL should be not used because it ceases to provide a stable and reliable result. In this case, the modified MWL may be used to approximate a solution to the σ-weighted ABE, which is given by:

$$σ w β = {σℬ}^{′} ( w β ) . \qquad ( Equation 10 )$$

The σ-weighted ABE always has a unique solution w_{*} which satisfies:

$$\begin{matrix}{C}_{★} = [ 𝔼 \{ {J}_{n} ( {w}_{★} ) - {ϵ}_{n} ( {w}_{★} ) \} , & 𝔼 \{ {J}_{n} ( {w}_{★} ) + {ϵ}_{n} ( {w}_{★} ) \} ] ,\end{matrix} \qquad ( Equation 11 )$$

regardless of the amount of data coverage. Accordingly, the modified MWL and the associated importance-sampling estimate Jₙ(ŵ) is shown to always be stable and reliable.

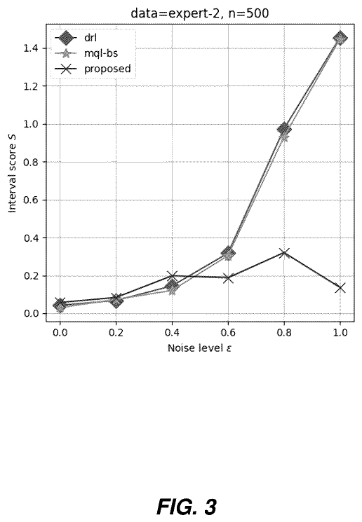

Referring to FIG. 3, a graph illustrating the effectiveness of the invention is shown where, if the data coverage does not hold because of high noise level ∈, the output of the invention is significantly better than those of conventional methods. It should be appreciated that as discussed herein above, the MWL loss may be determined by the MWL loss function as given by:

$${L}_{n} ( w ; f ) := 𝔼 {{s}_{0} \sim ι}_{{a}_{0} \sim π ( {s}_{0} )} [ f ( {s}_{0} , {a}_{0} ) ] - \frac{1}{n} {\sum }_{i = 1}^{n} [ w ( {s}_{i} , {a}_{i} ) \cdot \frac{f ( {s}_{i} , {a}_{i} ) - {γ𝔼}_{{a}_{i}^{′} \sim π ( {s}_{i}^{′} )} [ f ( {s}_{i}^{′} , {a}_{i}^{′} ) ]}{1 - γ} ] . \qquad ( Equation 12 )$$

The discriminator f(s, a) is multiplied with another function σ(s, a) in a point wise manner. It should be appreciated that the multiplier σ(s, a) may have approximately the same support with the probability density function β(s, a) of the data. As an example, consider the situation where σ(s, a)=\hat{β}(s, a) or σ(s, a)=\sqrt{\hat{β}(s, a)}, where \hat{β}(s, a) is an estimate of probability density β(s, a) of the data. Thus, the method of performing an interval-valued OPE based on the modified MWL, wherein the middle point of the interval is computed with the modified MWL and the half width of the interval may be computed using:

$${ϵ}_{n} ( \hat{w} ) := 1 - \frac{1}{n} {\sum }_{i = 1}^{n} \hat{w} ( {s}_{i} , {a}_{i} ) , \qquad ( Equation 13 )$$

where ŵ is the importance weight computed with the modified MWL.

Consider the situation where a set of possible states of the environment and possible actions taken by the target policy π are denoted by [symbol] and [symbol] , respectively. The offline data [symbol] may include a set of transition records [symbol] :={(sᵢ, aᵢ, rᵢ, sᵢ′)}ᵢ₌₁ⁿ. Here, n is the sample size, and for all 1≤i≤n, sᵢ∈ [symbol] is a state of the environment, aᵢ∈ [symbol] is the action taken in response to sᵢ (not necessarily by π) and rᵢ∈[−1, 1] and sᵢ′∈ [symbol] are the instantaneous reward and the successor state resulting from the action aᵢ, respectively. The discriminator set [symbol] and the associated function space may then be approximated as:

$$ℱ = \{ {θ}^{T} ϕ \vert θ ∈ {ℝ}^{d} , {‖ θ ‖}_{2} \leq 1 \} , \qquad ( Equation 14 )$$

where ϕ: [symbol] × [symbol] → [symbol] ^{d} is a basis function, θ^{T}ϕ:=Σⱼ₌₁^{d}θⱼϕⱼ is the function given by the inner product of θ and the output of ϕ, and ∥θ∥₂:=(Σⱼ₌₁^{d}θⱼ²)^{1/2} is the Euclid norm of θ.

The data density β may then be approximated with \hat{β} using the unconstrained least-squares importance fitting (uLSIF). In the situation, the uLSIF was applied with the feature mapping ϕ to estimate the density of the target dataset {(sᵢ, aᵢ)}ᵢ₌₁ⁿ with respect to reference dataset {(sᵢ, aᵢ)}ᵢ₌₁ⁿ∪{(s_{0,i}, a_{0,i})}ᵢ₌₁ⁿ∪{(sᵢ′, aᵢ′)}ᵢ₌₁ⁿ, where s_{0,i} is the i-th sample of the initial environment state, and a_{0,i}˜π(s_{0,i}) and aᵢ′˜(sᵢ′) are the π's responses to s_{0,i} and sᵢ′, respectively. The importance weight function may then be computed by minimizing the MWL loss function modified with the support function, i.e., σ=\sqrt{\hat{β}}, which may be given by:

$$\hat{w} := {arg min}_{w ∈ 𝒲} \{ {max}_{f ∈ ℱ} {L}_{n} ( w ; \sqrt{\hat{β}} f ) + λ Φ ( w ) \} , \qquad ( Equation 15 )$$

where [symbol] is the hypothesis set of importance weight, Lₙ(w; f) is the loss function of MWL, λ>0 is the regularization weight, and Φ(w) is the regularization function. In another embodiment, the basis function may be reused to set [symbol] :={w_{θ}≡θ^{T}ϕ|∈ [symbol] ^{d}} and

$$Φ ( {w}_{θ} ) := \frac{1}{2} {‖ θ ‖}_{2} .$$

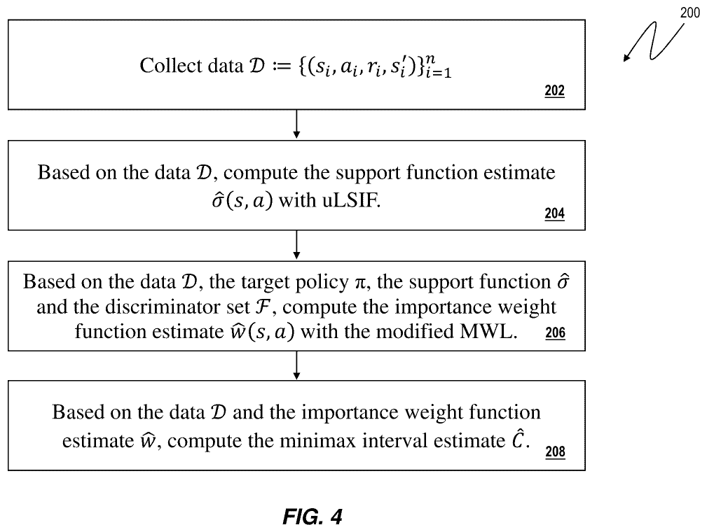

Referring to FIG. 4, a method 200 for performing an Interval-Based Offline Policy Evaluation (OPE) based on the importance sampling, where the importance sampling is computed using a modification of the Minimax Weight Learning (MWL) is provided, in accordance with an embodiment of the invention. The method 200 includes collecting a dataset [symbol] :={(sᵢ, aᵢ, rᵢ, sᵢ′)}ᵢ₌₁ⁿ, as shown in operational block 202, wherein the data in the dataset [symbol] which may be sampled from the following distribution:

$${G}_{β , M} ( 𝒟 ) = {\prod }_{i = 1}^{n} β ( {s}_{i} , {a}_{i} ) R ( {r}_{i} \vert {s}_{i} , {a}_{i} ) T ( {s}_{i}^{′} \vert {s}_{i} , {a}_{i} ) ,$$

where β(sᵢ, aᵢ) is the behavior distribution. Based on the dataset [symbol] , the support function estimate \hat{σ}(s, a) is computed using an unconstrained Least-Squares Importance Fitting (uLSIF) algorithm, as shown in operational block 204. Generally, the sLSIF algorithm is an algorithm to directly estimate the ratio of two density functions without going through a density estimation. Based on the dataset [symbol] , the target policy π, the support function \hat{σ} and the discriminator set [symbol] , the importance weight function estimate ŵ(s, a) is computed using the modified MWL (Equation 8), as shown in operational block 206. The method further includes computing the minimax interval estimate Ĉ (equation 5) based on the dataset [symbol] and the importance weight function estimate ŵ, as shown in operational block 208.

Various aspects of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of β8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein. Moreover, the embodiments or parts of the embodiments may be combined in whole or in part without departing from the scope of the invention.

What is claimed is:

1. A method of performing an Offline Policy Evaluation (OPE) based on the importance sampling, comprising:
collecting a dataset D, wherein D is given by [symbol] :={(sᵢ, aᵢ, rᵢ, sᵢ′})ᵢ₌₁ⁿ;
identifying a target policy π;
calculating a support function estimate \hat{σ}(s, a), wherein the support function estimate \hat{σ}(s, a) is responsive to the dataset D;
identifying a discriminator set F;
calculating an importance weight estimate ŵ(s, a) responsive to the dataset D, the target policy π, the support function estimate \hat{σ} and the discriminator set F; and
calculating a minimax interval estimate Ĉ responsive to the dataset D and the importance weight estimate ŵ.

2. The method of claim 1, wherein an output of the OPE is an interval indicating an uncertainty of the evaluation, and
a middle point of the interval is computed with a modified MWL and a half width of the interval ∈ₙ(ŵ) is computed with
$${ϵ}_{n} ( \hat{w} ) := 1 - \frac{1}{n} {Σ}_{i = 1}^{n} \hat{w} ( {s}_{i} , {a}_{i} ) .$$

3. The method of claim 1, wherein the dataset D is sampled from a distribution given by:
$${G}_{β , M} ( 𝒟 ) = {\prod }_{i = 1}^{n} β ( {s}_{i} , {a}_{i} ) R ( {r}_{i} \vert {s}_{i} , {a}_{i} ) T ( {{s}^{′}}_{i} \vert {s}_{i} , {a}_{i} ) .$$

4. The method of claim 1, wherein the minimax interval estimate Ĉ is given by,
$$\hat{C} := [ {J}_{n} ( \hat{w} ) - {ϵ}_{n} ( \hat{w} ) , {J}_{n} ( \hat{w} ) + {ϵ}_{n} ( \hat{w} ) ] ,$$
where Jₙ(ŵ) is the importance-sampling estimate and ∈ₙ(ŵ) is the error estimate.

5. The method of claim 4, wherein the importance-sampling estimate Jₙ(ŵ) is given by,
$${J}_{n} ( \hat{w} ) := \frac{1}{n} {\sum }_{i = 1}^{n} [ {r}_{i} \cdot \hat{w} ( {s}_{i} , {a}_{i} ) ] ,$$
and wherein the error estimate ∈ₙ(ŵ) is given by,
$${ϵ}_{n} ( \hat{w} ) := 1 - \frac{1}{n} {\sum }_{i = 1}^{n} \hat{w} ( {s}_{i} , {a}_{i} ) .$$

6. The method of claim 1, where the discriminator set F is given by
$$ℱ = \{ {θ}^{⊤} ϕ \vert θ ∈ {ℝ}^{d} , {‖θ‖}_{2} \leq 1 \} ,$$
where ϕ: [symbol] × [symbol] → [symbol] ^{d} is a basis function, θ^{T}ϕ:=Σⱼ₌₁^{d}θⱼϕⱼ is the function given by the inner product of θ and the output of ϕ, and ∥θ∥₂:=(Σⱼ₌₁^{d}θⱼ²)^{1/2} is the Euclid norm of θ.

7. The method of claim 2, wherein the modified MWL is given by,
$$\hat{w} := {argmin}_{w ∈ 𝒲} {max}_{f ∈ ℱ} {L}_{n} ( w ; σ f ) ,$$
where Lₙ(w, f) is a loss function of MWL, [symbol] is a hypothesis sets of the importance weight, [symbol] is a hypothesis set of the “discriminator” and σ is a support function satisfying supp(σ)=supp(β) (e.g.) σ=β, \sqrt{β}.

8. The method of claim 2, wherein the modification of the modified MWL includes, multiplying a discriminator f(s, a) of a loss function of the MWL by a support function σ(s, a) in a point-wise manner, where the support function σ(s, a) has about the same support with the probability density function β(s, a) of an offline dataset.

9. The method of claim 1, wherein the support function estimate \hat{σ}(s, a) is computed using an unconstrained Least-Squares Importance Fitting (uLSIF) algorithm.

10. A computing system, comprising:
a machine learning system for implementing a method for performing an Offline Policy Evaluation (OPE) based on the importance sampling, the system configured to:
collect a dataset D, wherein D is given by [symbol] :={(sᵢ, aᵢ, rᵢ, sᵢ′)}ᵢ₌₁ⁿ;
identifying a target policy π;
calculate a support function estimate \hat{σ}(s, a), wherein the support function estimate \hat{σ}(s, a) is responsive to the dataset D;
identify a discriminator set F;
calculate an importance weight estimate ŵ(s, a) responsive to the dataset D, the target policy π, the support function estimate \hat{σ} and the discriminator set F; and
calculate a minimax interval estimate Ĉ responsive to the dataset D and the importance weight estimate ŵ.

11. The computing system of claim 10, wherein an output of the OPE is an interval indicating an uncertainty of the evaluation, and
a middle point of the interval is computed with a modified MWL and a half width of the interval ∈ₙ(ŵ) is computed with
$${ϵ}_{n} ( \hat{w} ) := 1 - \frac{1}{n} {Σ}_{i = 1}^{n} \hat{w} ( {s}_{i} , {a}_{i} ) .$$

12. The computing system of claim 10, wherein the dataset D is sampled from a distribution given by:
$${G}_{β , M} ( 𝒟 ) = {\prod }_{i = 1}^{n} β ( {s}_{i} , {a}_{i} ) R ( {r}_{i} \vert {s}_{i} , {a}_{i} ) T ( {{s}^{′}}_{i} \vert {s}_{i} , {a}_{i} ) .$$

13. The computing system of claim 10, wherein the minimax interval estimate Ĉ is given by,
$$\hat{C} := [ \begin{matrix}{J}_{n} ( \hat{w} ) - {ϵ}_{n} ( \hat{w} ) , & {J}_{n} ( \hat{w} ) + {ϵ}_{n} ( \hat{w} )\end{matrix} ] ,$$
where Jₙ(ŵ) is the importance-sampling estimate and ∈ₙ(ŵ) is the error estimate.

14. The computing system of claim 13, wherein the importance-sampling estimate Jₙ(ŵ) is given by,
$${J}_{n} ( \hat{w} ) := \frac{1}{n} {\sum }_{i = 1}^{n} [ {r}_{i} \cdot \hat{w} ( {s}_{i} , {a}_{i} ) ] ,$$
And wherein the error estimate ∈ₙ(ŵ) is given by,
$${ϵ}_{n} ( \hat{w} ) := 1 - \frac{1}{n} {\sum }_{i = 1}^{n} \hat{w} ( {s}_{i} , {a}_{i} ) .$$

15. The computing system of claim 10, where the discriminator set F is given by
$$ℱ = \{ {θ}^{⊤} ϕ \vert θ ∈ {ℝ}^{d} , {‖θ‖}_{2} \leq 1 \} ,$$
where ϕ: [symbol] × [symbol] → [symbol] ^{d} is a basis function, θ^{T}ϕ:=Σⱼ₌₁^{d}θⱼϕⱼ is the function given by the inner product of θ and the output of ϕ, and ∥θ∥₂:=(Σⱼ₌₁^{d}θⱼ²)^{1/2} is the Euclid norm of θ.

16. The computing system of claim 11, wherein the modified MWL is given by,
$$\hat{w} := {argmin}_{w ∈ 𝒲} {max}_{f ∈ ℱ} {L}_{n} ( w ; σ f ) ,$$
where Lₙ(w, f) is a loss function of MWL, [symbol] is a hypothesis sets of the importance weight, [symbol] is a hypothesis set of the “discriminator” and σ is a support function satisfying supp(σ)=supp(β) (e.g.) σ=β, \sqrt{β}.

17. The computing system of claim 11, wherein the modification of the modified MWL includes, multiplying a discriminator f(s, a) of a loss function of the MWL by a support function σ(s, a) in a point-wise manner, where the support function σ(s, a) has about the same support with the probability density function β(s, a) of an offline dataset.

18. The computing system of claim 10, wherein the support function estimate \hat{σ}(s, a) is computed using an unconstrained Least-Squares Importance Fitting (uLSIF) algorithm.

19. A computer program product comprising a computer readable storage medium having program instructions embodied therewith, the program instructions executable by a processor to cause the processor to perform operations comprising:
performing an Offline Policy Evaluation (OPE) based on the importance sampling, wherein performing comprises:
collecting a dataset D, wherein D is given by [symbol] :={(sᵢ, aᵢ, rᵢ, sᵢ′)}ᵢ₌₁ⁿ;
identifying a target policy π;
calculating a support function estimate \hat{σ}(s, a), wherein the support function estimate \hat{σ}(s, a) is responsive to the dataset D;
identifying a discriminator set F;
calculating an importance weight estimate ŵ(s, a) responsive to the dataset D, the target policy π, the support function estimate \hat{σ} and the discriminator set F; and
calculating a minimax interval estimate Ĉ responsive to the dataset D and the importance weight estimate ŵ.

20. The computer program product of claim 19, wherein the minimax interval estimate Ĉ is given by,
$$\hat{C} := [ \begin{matrix}{J}_{n} ( \hat{w} ) - {ϵ}_{n} ( \hat{w} ) , & {J}_{n} ( \hat{w} ) + {ϵ}_{n} ( \hat{w} )\end{matrix} ] ,$$
where Jₙ(ŵ) is the importance-sampling estimate and ∈ₙ(ŵ) is the error estimate.
